(19) United States
(12) Patent Application Publication
(10) Pub. No.: US 2018/0366797 A1
(43) Pub. Date: Dec. 20, 2018

(54) TRI-ELECTRODE ZINC-AIR FUEL CELL

(71) Applicant: USAN TECHNOLOGY INC., Taipei City (TW)

(72) Inventor: Wen Huang LIAO, Taipei City (TW)

(73) Assignee: USAN TECHNOLOGY INC., Taipei City (TW)

(21) Appl. No.: 15/622,799

(22) Filed: Jun. 14, 2017

(51) Int. Cl. H01M 12/02; H01M 12/08; H01M 4/38

(52) U.S. Cl. CPC H01M 12/02; H01M 4/38; H01M 12/08

(57) ABSTRACT

A tri-electrode zinc-air fuel cell includes a casing; an air electrode layer being a discharge positive electrode in a chemical discharging reaction; a metal layer being a charge positive electrode in a chemical charging reaction; a zinc material working with the air electrode layer to be a negative electrode in the chemical discharging or with the metal layer to be a negative electrode in the chemical charging; separation membranes separating the air electrode, the metal layer and the zinc material from one another; and an electrolyte permeable through the separation membranes to electrically connect the air electrode layer, the metal layer and the zinc material to one another. By inputting or outputting the electrolyte to change its level in the casing and the above components that can contact with the electrolyte, the tri-electrode zinc-air fuel cell can be switched between ON and OFF as well as Charge and Discharge states.

### FIELD OF THE INVENTION

The present invention relates to a fuel cell using a zinc material and air to enable oxidation-reduction reactions; and more particularly, to a tri-electrode zinc-air fuel cell that is electrically connected to other external electronic products via three electrode connectors.

### BACKGROUND OF THE INVENTION

The use of fuel cells as an energy source belongs to a scientific field of directly converting chemical energy into electrical energy. The fuel cell has high density of energy during the process of producing energy, and the energy produced by the fuel cell is an electrical energy generated due to a potential difference between a positive and a negative electrode of the fuel cell. Since fuel cells are almost environmental pollution-free, both of the academic and the industrial field are devoted to the research and development of fuel cells in an attempt to make revolutionary improvements on the global hazards caused by carbon-emission, energy shortage and environmental pollution.

A conventional zinc-air fuel cell (ZAFC) generally internally includes an air electrode, a zinc anode, an electrolyte storage space and an electrolyte. In the zinc-air fuel cell, the air electrode and the zinc anode are directly immersed in the electrolyte. As a result, the zinc anode tends to become polarized and passivated and has crystal dendrite grown on its surface, which in turn causes quick corrosion of the zinc anode, reduced zinc-air fuel cell performance, oxidation of electrolyte, and shortened cell operating life.

### SUMMARY OF THE INVENTION

A primary object of the present invention is to provide a tri-electrode zinc-air fuel cell, of which an electrolyte can be partially or fully removed therefrom when the fuel cell is not in use and to be stored, so that two positive electrodes of the fuel cell are not in contact with the electrolyte and no electrochemical reaction will occur to thereby avoid corrosion or surface dissociation of two positive and one negative electrodes of the fuel cell. Therefore, the fuel cell can have prolonged storage life and operating life.

Another object of the present invention is to provide a tri-electrode zinc-air fuel cell, which includes two positive electrodes and one negative electrode and can therefore enable chemical charging and discharging reactions at the same time within one single fuel cell.

A further object of the present invention is to provide a tri-electrode zinc-air fuel cell, which uses a zinc material and an electrolyte at the same time and includes a delivery device for delivering both or one of the zinc material and the electrolyte into or out of the fuel cell, allowing convenient replacement of the zinc material and/or the electrolyte.

To achieve the above and other objects, the tri-electrode zinc-air fuel cell provided according to the present invention includes a casing internally defining a receiving space; an air electrode layer serving as a discharge positive electrode in a chemical discharging reaction; a metal layer serving as a charge positive electrode in a chemical charging reaction; a zinc material for working with the air electrode layer to serve as a negative electrode in the chemical discharging reaction or with the metal layer to serve as a negative electrode in the chemical charging reaction; a plurality of separation membrane layers disposed between the air electrode layer and the metal layer, as well as between the metal layer and the zinc material to separate the air electrode layer, the metal layer and the zinc material from one another; and an electrolyte permeable through the separation membrane layers to contact with and accordingly electrically connect the air electrode layer, the metal layer and the zinc material to one another. All of the air electrode layer, the metal layer, the zinc material, the separation membrane layers and the electrolyte are arranged in the receiving space.

In an operable preferred embodiment of the present invention, the metal layer is a stainless steel layer made of a stainless steel material.

According to the present invention, the tri-electrode zinc-air fuel cell can further include a conducting layer arranged in the receiving space to be in direct contact with the zinc material. And, in at least one operable preferred embodiment of the present invention, the conducting layer is made of a copper or a nickel metal material.

According to the present invention, the zinc material can be any one of fluid zinc paste, zinc sand and a zinc plate. The conducting layer for correspondingly using with the zinc material might be different in configuration, depending on the form of the zinc material selected for use.

In the case the selected zinc material is fluid zinc paste, the conducting layer selected for use includes a central area and a peripheral area surrounding the central area, and the central area is lower than the peripheral area to form a recess on the conducting layer.

In the case the selected zinc material is zinc sand, the conducting layer selected for use can be a flat sheet.

In the case the selected zinc material is a zinc plate, the conducting layer can be omitted and the zinc plate can be directly used in place of the conducting layer for guiding out electrical current.

Further, when a surface for placing the fuel cell is used as a horizontal reference plane, the air electrode layer, the metal layer and the zinc material in the fuel cell of the present invention are horizontally arranged from top to bottom, which is different from other conventional fuel cells that are vertically placed with the electrodes and zinc material thereof being vertically arranged side by side.

In a most preferable embodiment of the present invention, the air electrode layer is arranged in the fuel cell at a highest position, the zinc material at a lowest position, and the metal layer between the air electrode layer and the zinc material with the conducting layer, if any, being arranged below the zinc material.

According to the present invention, the casing includes a first case and a second case assembled to each other. The air electrode layer, the metal layer and the separation membrane layers are positioned in and connected to the first case while the conducting layer is positioned in and connected to the second case. And, the first case is fitted in the second case.

The tri-electrode zinc-air fuel cell of the present invention can further include a delivery device, which is communicably connected to the receiving space for delivering the electrolyte into or out of the receiving space and accordingly, changing a level of the electrolyte in the receiving space. By changing a total volume and the level of the electrolyte in the receiving space, it is possible to change the structural components in the receiving space that can contact with the electrolyte. That is, by controlling the level of the electrolyte in the receiving space, it is able to prevent internal structural components of the fuel cell located at specific heights and positions from contacting with the electrolyte and accordingly prevent these specific structural components from corrosion or surface dissociation.

In summary, the present invention is characterized in using a zinc material as the negative electrode while using an air electrode layer and a metal layer as the positive electrodes; and the two positive electrodes and the single negative electrode together constitute a tri-electrode structure for the zinc-air fuel cell.

Further, since a delivery device can be communicably connected to the receiving space in the tri-electrode zinc-air fuel cell to change the total volume and the level of the electrolyte in the receiving space, a large part of the electrolyte can be removed from the receiving space when the tri-electrode zinc-air fuel cell is not in use and to be stored for a long time. In this manner, the internal structural components are not in contact with the electrolyte and no chemical discharging and charging reactions will occur in the fuel cell. In this case, the structural components in the receiving space are not subjected to corrosion or surface dissociation to ensure prolonged storage life and operating life of the tri-electrode zinc-air fuel cell.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a tri-electrode zinc-air fuel cell according to a first preferred embodiment of the present invention;

FIG. 2 is an exploded view of FIG. 1;

FIG. 3 is a sectional view of FIG. 1;

FIG. 4 is a sectional view showing a first possible level of an electrolyte in the tri-electrode zinc-air fuel cell of the present invention;

FIG. 5 is a sectional view showing a second possible level of the electrolyte in the tri-electrode zinc-air fuel cell of the present invention;

FIG. 6 is a sectional view showing a third possible level of the electrolyte in the tri-electrode zinc-air fuel cell of the present invention;

FIG. 7 is a sectional view of a tri-electrode zinc-air fuel cell according to a second preferred embodiment of the present invention;

FIG. 8 is a sectional view of a tri-electrode zinc-air fuel cell according to a third preferred embodiment of the present invention; and

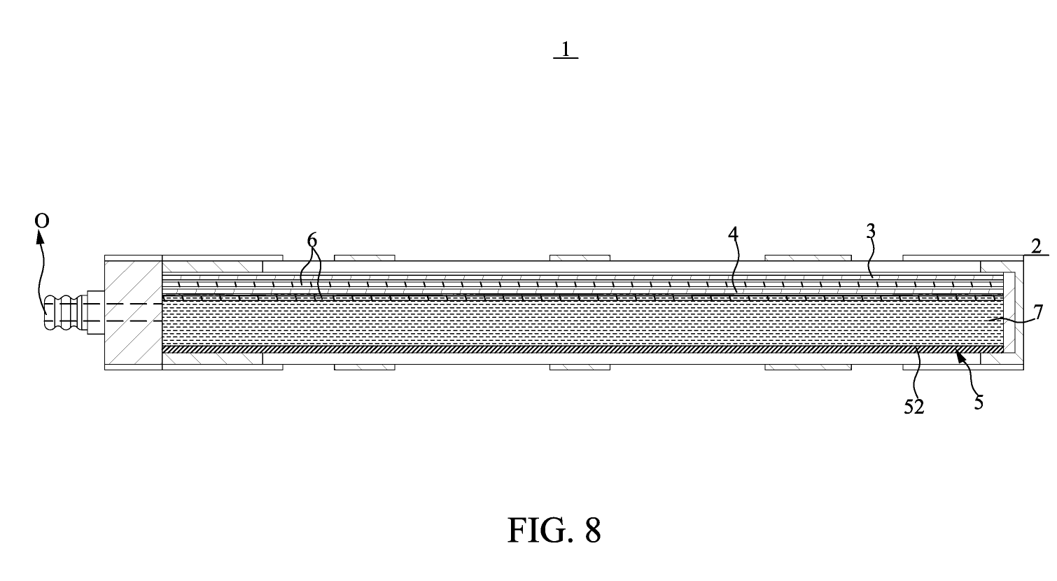

FIG. 9 is a perspective view of a large-scale fuel cell device formed by assembling a plurality of tri-electrode zinc-air fuel cells of the present invention to one another.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

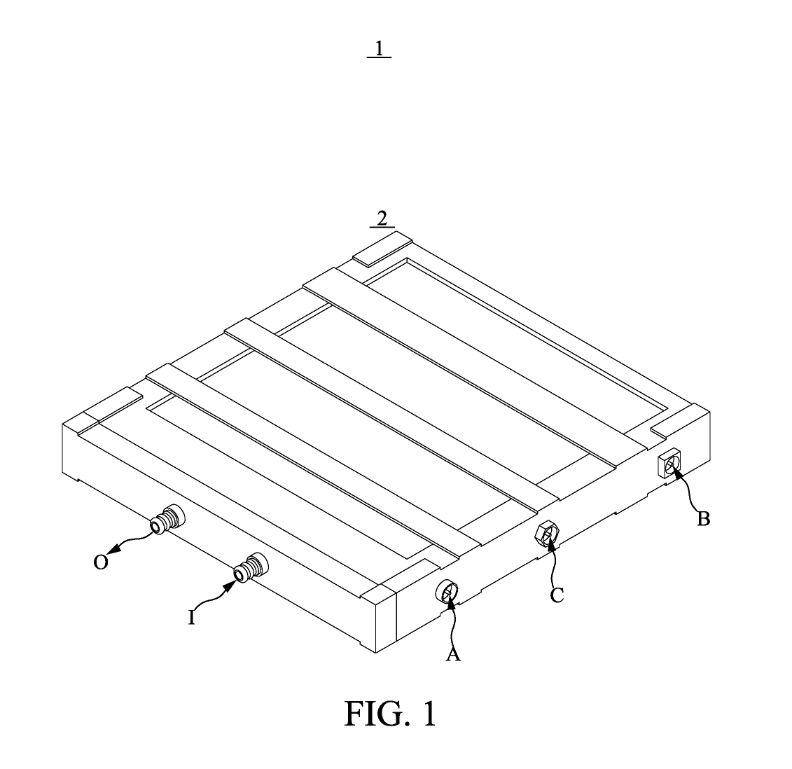

Please refer to FIGS. 1 to 6. A tri-electrode zinc-air fuel cell 1 according to a first preferred embodiment of the present invention includes seven major structural components, namely, a casing 2, an air electrode layer 3, a metal layer 4, a zinc material 5, a plurality of separation membrane layers 6, an electrolyte 7 and a conducting layer 8.

The casing 2 includes a first case 20 and a second case 21. The first case 20 is fitted in and locked to the second case 21, so that the first and second cases 20, 21 together define a receiving space 22 therein. The air electrode layer 3, the metal layer 4, the electrolyte 7, the zinc material 5 and the conducting layer 8 are sequentially horizontally arranged in the receiving space 22 from top to bottom relative to a horizontal surface on which the fuel cell is placed. The air electrode layer 3, the metal layer 4 and the separation membrane layers 6 are positioned in and connected to the first case 20, while the conducting layer 8 is positioned in and connected to the second case 21.

On an outer surface of the casing 2, a discharging connector A, a charging connector B and a negative electrode connector C are provided for guiding out and guiding in electrical energy produced by the tri-electrode zinc-air fuel cell 1 of the present invention. The air electrode layer 3 serves as a discharge positive electrode in a chemical discharging reaction and has an integrally extended portion to form a first electrical connecting section 30, via which the air electrode layer 3 is electrically connected to the discharging connector A.

The metal layer 4 serves as a charge positive electrode in a chemical charging reaction and has an integrally extended portion to form a second electrical connecting section 41, via which the metal layer 4 is electrically connected to the charging connector B.

The zinc material 5 can work with the air electrode layer 3 to serve as a negative electrode in the chemical discharging reaction and/or with the metal layer 4 to serve as a negative electrode in the chemical charging reaction, simultaneously or separately. The conducting layer 8 has an integrally extended portion to form a third electrical connecting section 83, via which the conducting layer 8 is electrically connected to the negative electrode connector C. It is noted the negative electrode connector C has a relative position located between the discharging connector A and the charging connector B.

Further, an input connector I (INPUT) and an output connector O (OUTPUT) are provided on another outer surface of the casing 2, such that the receiving space 22 in the casing 2 can be communicably connected to an external delivery device 9 via the input connector I and the output connector O. The delivery device 9 is able to deliver the zinc material 5 or the electrolyte 7 into or out of the tri-electrode zinc-air fuel cell 1. The electrolyte 7 is permeable through the separation membrane layers 6 to electrically connect the structural components in the receiving space 22 to one another. Therefore, by operating the delivery device 9, a total volume and accordingly a level of the electrolyte 7 in the receiving space 22 can be decreased to switch the tri-electrode zinc-air fuel cell 1 to an OFF state, in which the structural components in the receiving space 22 are not electrically connected to one another via the electrolyte 7, or be increased to switch the tri-electrode zinc-air fuel cell 1 to an ON state, in which some specific structural components in the receiving space 22 are electrically connected to one another via the electrolyte 7. According to the present invention, the ON state of the tri-electrode zinc-air fuel cell 1 can be presented in three different manners, which will be described in details below with reference to related figures.

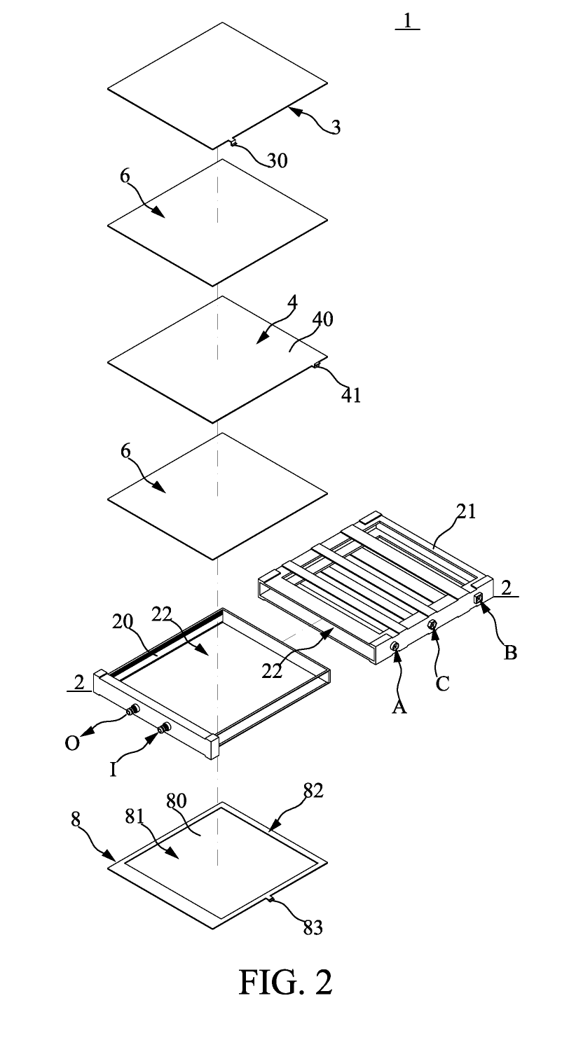

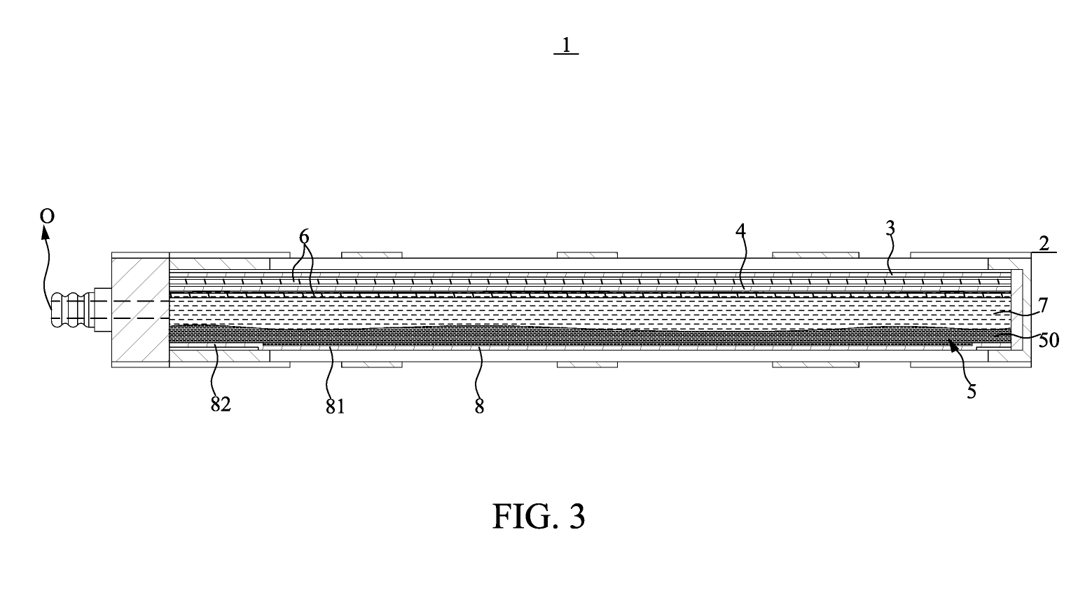

Referring to FIGS. 2 and 3. As shown in these drawings, the air electrode layer 3 is located highest in the receiving space 22, a first one of the separation membrane layers 6 is disposed between the air electrode layer 3 and the metal layer 4 to separate the two layers 3, 4 from each other, and a second one of the separation membrane layers 6 is disposed between the metal layer 4 and the conducting layer 8 to separate the two layers 4, 8 from each other. The zinc material 5 is distributed between the second separation membrane layer 6 and the conducting layer 8. According to an operable preferred embodiment of the present invention, the metal layer 4 is a stainless steel layer 40, and the conducting layer 8 is a sheet-like metal member 80. In the first preferred embodiment of the present invention shown in FIGS. 1 to 6, the zinc material 5 is fluid zinc paste 50. As shown in FIGS. 2 and 3, the metal member 80 includes a central area 81 and a peripheral area 82 surrounding the central area 81. The central area 81 is lower than the peripheral area 82 to form a recess, in which the zinc paste 50 is retained. When the delivery device 9 delivers the electrolyte 7 into or out of the receiving space 22, the zinc paste 50 retained in the recessed central area 81 won't be changed in terms of its distribution area over the conducting layer 8 or be sucked into the delivery device 9 along with the electrolyte 7.

In FIG. 3, the illustrated electrolyte 7 is distributed over the zinc paste 50 and its level in the receiving space 22 is flush with or just above the second separation membrane layer 6. With this level of electrolyte 7, the air electrode layer 3 and the metal layer 4 are not electrically connected to the zinc paste 50 via the electrolyte 7. Accordingly, the tri-electrode zinc-air fuel cell 1 shown in FIG. 3 is in an OFF state.

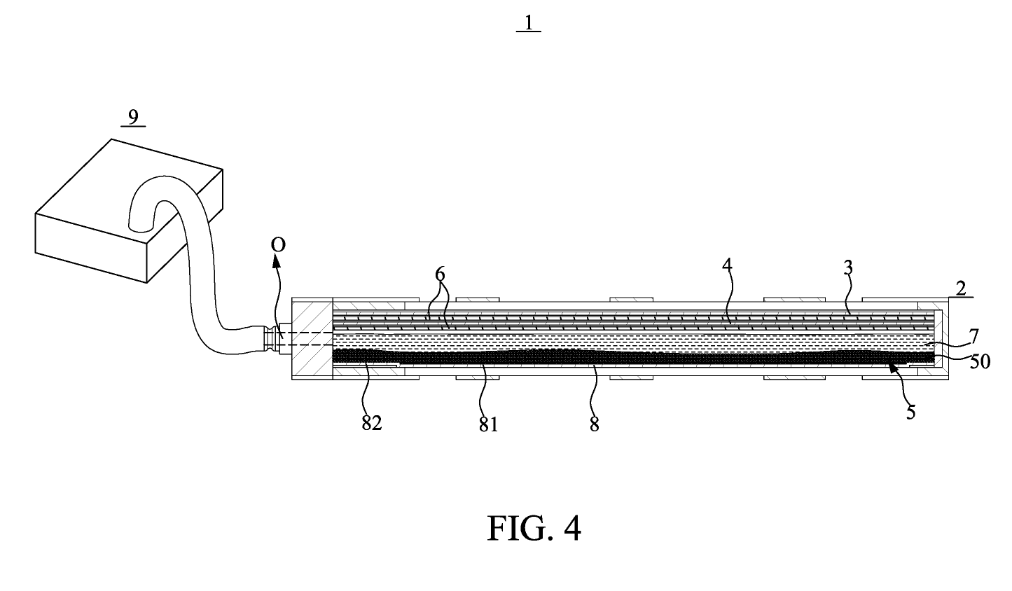

In FIG. 4, the illustrated electrolyte 7 has a level simply high enough for covering a top surface of the zinc paste 50. In this case, the air electrode layer 3 and the metal layer 4 are not electrically connected to the zinc paste 50 via the electrolyte 7 and no electrochemical reaction occurs in the receiving space 22. Therefore, the tri-electrode zinc-air fuel cell 1 shown in FIG. 4 is in an OFF state.

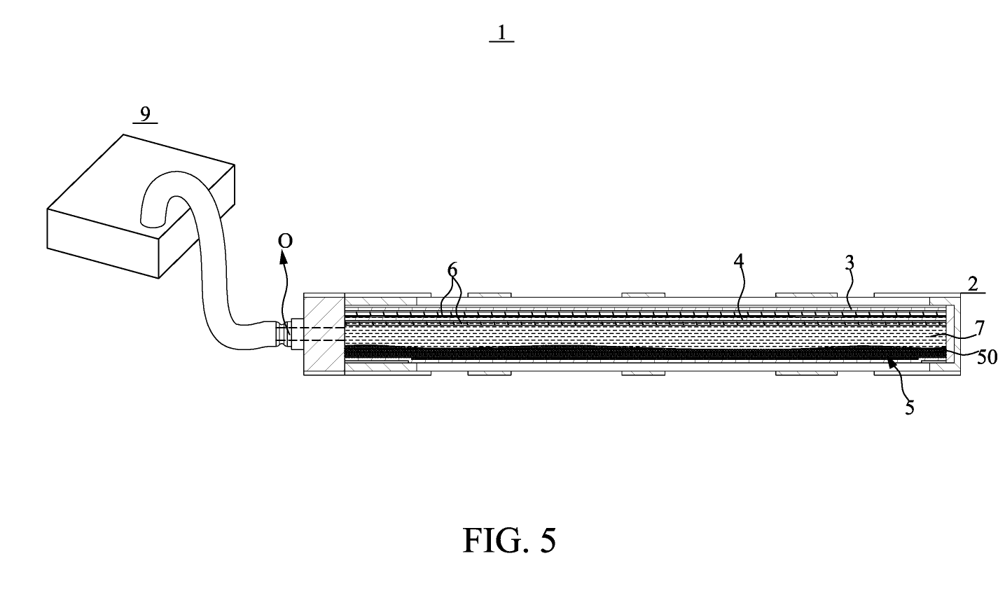

In FIG. 5, the illustrated electrolyte 7 has a level high enough to cover the metal layer 4, the second separation membrane layer 6 and the zinc paste 50, allowing a chemical charging reaction to occur in the receiving space 22. Therefore, the tri-electrode zinc-air fuel cell 1 shown in FIG. 5 is in an ON state. On the other hand, in the case the air electrode layer 3 and the metal layer 4 are exchanged in position (not shown), the electrolyte 7 illustrated in FIG. 5 shall cover the air electrode layer 3, the second separation membrane layer 6 and the zinc paste 50. In this case, a chemical discharging reaction can occur in the receiving space 22 and the tri-electrode zinc-air fuel cell 1 is similarly in an ON state.

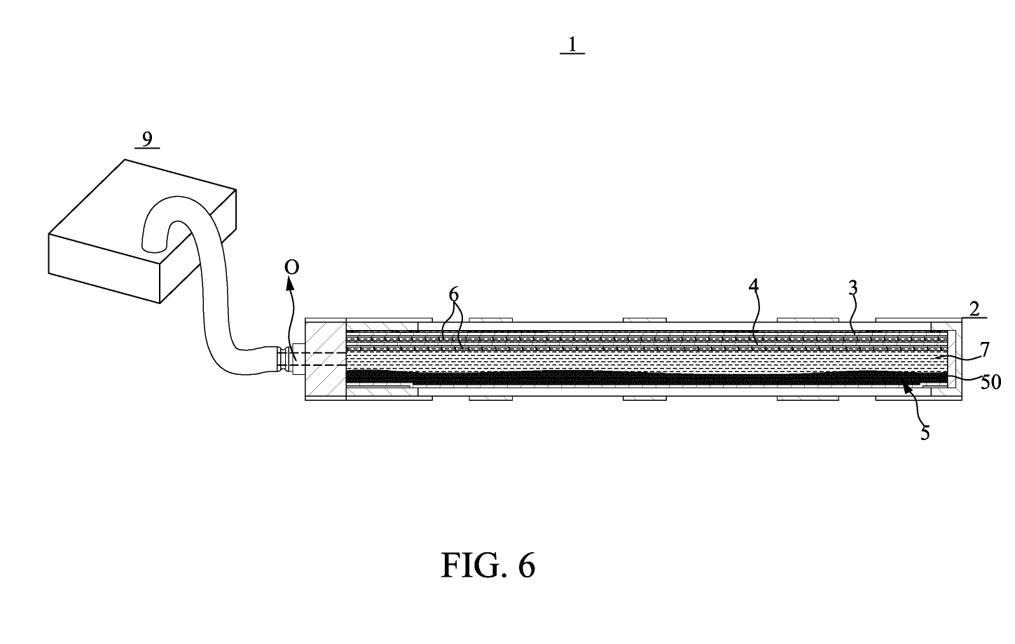

In FIG. 6, the illustrated electrolyte 7 has a level high enough to cover all the structural components arranged in the receiving space 22, allowing the chemical charging reaction and the chemical discharging reaction to occur at the same time in the receiving space 22. Therefore, the tri-electrode zinc-air fuel cell 1 shown in FIG. 6 is in an ON state.

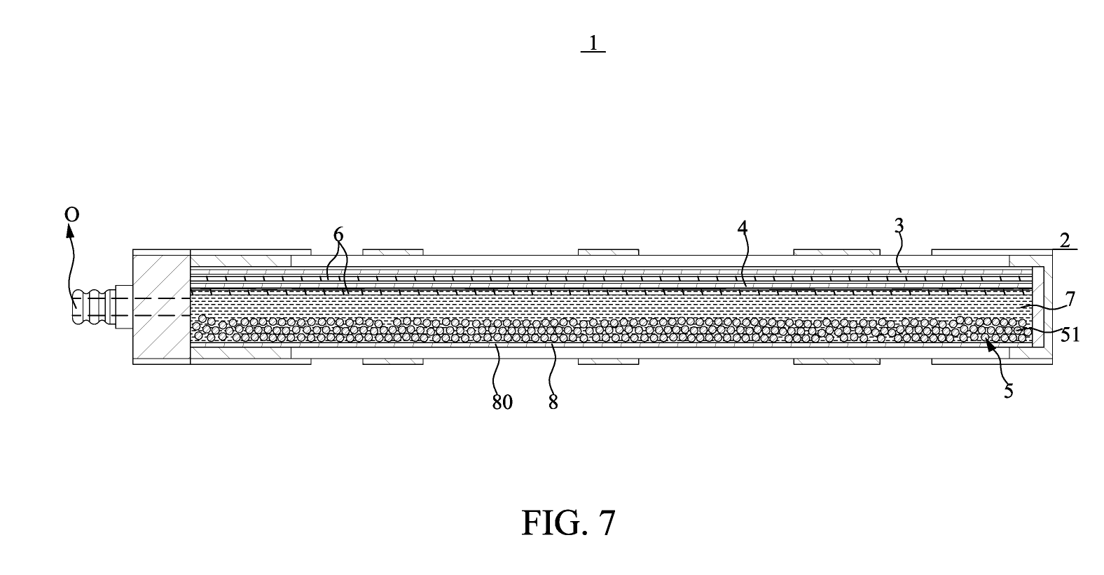

Please refer to FIG. 7, in which a tri-electrode zinc-air fuel cell 1 according to a second preferred embodiment of the present invention is shown. The second preferred embodiment is different from the first one in that the zinc material 5 thereof is in the form of zinc sand 51 and the metal member 80 forming the conducting layer 8 is a flat sheet. Since the zinc sand 51 in the receiving space 22 would not change in position when the electrolyte 7 is delivered into or out of the receiving space 22, it is not necessary to form a recess on the conducting layer 8 in the second preferred embodiment of the present invention. Since the tri-electrode zinc-air fuel cell 1 in the second preferred embodiment of the present invention is the same as the first preferred embodiment in all other technical features, it is not repeatedly described herein.

FIG. 7 shows a tri-electrode zinc-air fuel cell 1 according to a third preferred embodiment of the present invention. The third preferred embodiment is different from the first and the second one in that the zinc material 5 thereof is in the form of a zinc plate 52 and the conducting layer 8 is no longer necessary in this case. Since the tri-electrode zinc-air fuel cell 1 in the third preferred embodiment of the present invention is the same as the first and the second preferred embodiment in all other technical features, it is not repeatedly described herein.

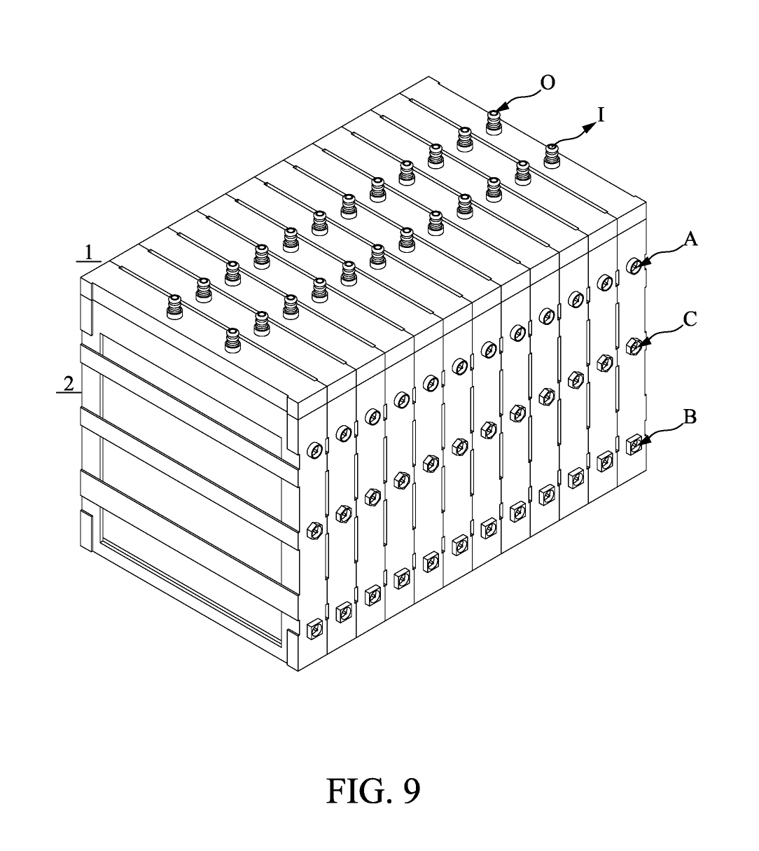

Finally, please refer to FIG. 9, which shows a relatively large scaled tri-electrode zinc-air fuel cell device formed by stacking and assembling a plurality of the tri-electrode zinc-air fuel cells 1 to one another.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A tri-electrode zinc-air fuel cell, comprising:
a casing internally defining a receiving space;
an air electrode layer arranged in the receiving space to serve as a discharge positive electrode in a chemical discharging reaction;
a metal layer arranged in the receiving space to serve as a charge positive electrode in a chemical charging reaction;
a zinc material disposed in the receiving space for working with the air electrode layer to serve as a negative electrode in the chemical discharging reaction or with the metal layer to serve as a negative electrode in the chemical charging reaction;
a plurality of separation membrane layers disposed between the air electrode layer and the metal layer, as well as between the metal layer and the zinc material to separate the air electrode layer, the metal layer and the zinc material from one another; and
an electrolyte disposed in the receiving space and being permeable through the separation membrane layers to contact with and accordingly electrically connect the air electrode layer, the metal layer and the zinc material to one another.

2. The tri-electrode zinc-air fuel cell as claimed in claim 1, further comprising a conducting layer arranged in the receiving space and being in direct contact with the zinc material.

3. The tri-electrode zinc-air fuel cell as claimed in claim 2, wherein the conducting layer includes a central area and a peripheral area surrounding the central area; and the central area being lower than the peripheral area to form a recess on the conducting layer.

4. The tri-electrode zinc-air fuel cell as claimed in claim 3, wherein the zinc material is selected from the group consisting of fluid zinc paste, zinc sand and a zinc plate.

5. The tri-electrode zinc-air fuel cell as claimed in claim 1, wherein the air electrode layer, the metal layer and the zinc material are horizontally arranged in the receiving space from top to bottom.

6. The tri-electrode zinc-air fuel cell as claimed in claim 5, wherein the air electrode layer is arranged at a highest position in the receiving space, the zinc material is arranged at a lowest position in the receiving space, and the metal layer is arranged between the air electrode layer and the zinc material.

7. The tri-electrode zinc-air fuel cell as claimed in claim 2, wherein the casing includes a first case and a second case assembled to each other; and the air electrode layer, the metal layer and the separation membrane layers being positioned in and connected to the first case while the conducting layer is positioned in and connected to the second case.

8. The tri-electrode zinc-air fuel cell as claimed in claim 1, further comprising a delivery device communicably connected to the receiving space for delivering the electrolyte into or out of the receiving space and accordingly, changing a level of the electrolyte in the receiving space.

9. The tri-electrode zinc-air fuel cell as claimed in claim 1, wherein the electrolyte in the receiving space can have a variable level; the tri-electrode zinc-air fuel cell being in an ON state to enable occurrence of the charging reaction or the discharging reaction when the level of the electrolyte is high enough to simultaneously contact with the air electrode layer, the metal layer and the zinc material; the tri-electrode zinc-air fuel cell being in an ON state to enable occurrence of the discharging reaction when the level of the electrolyte is high enough to simultaneously contact with the air electrode layer and the zinc material; the tri-electrode zinc-air fuel cell being in an ON state to enable occurrence of the charging reaction when the level of the electrolyte is high enough to simultaneously contact with the metal layer and the zinc material; and the tri-electrode zinc-air fuel cell being in an OFF state without any chemical discharging or charging reaction when the level of the electrolyte is low and can contact with only one of the air electrode layer, the metal layer and the zinc material.

10. The tri-electrode zinc-air fuel cell as claimed in claim 1, wherein the casing is provided on an outer surface with a discharging connector, a charging connector and a negative electrode connector corresponding to the discharge positive electrode, the charge positive electrode and the negative electrode, respectively; and the negative electrode connector being located between the discharging connector and the charging connector.
